(19) United States
(12) Patent Application Publication
(10) Pub. No.: US 2024/0081193 A1
(43) Pub. Date: Mar. 14, 2024

(54) AGRICULTURAL UNIT

(71) Applicant: VAHAA DIKEY TARIM COZUMLERI VE TEKNOLOJI ANONIM SIRKETI, Istanbul (TR)

(72) Inventors: Yunus Emre BOYACIOGLU, Istanbul (TR); Orhan CELEBI, Istanbul (TR); Selime Nehir BOYACIOGLU, Istanbul (TR)

(73) Assignee: VAHAA DIKEY TARIM COZUMLERI VE TEKNOLOJI ANONIM SIRKETI, Istanbul (TR)

(21) Appl. No.: 18/260,048

(22) PCT Filed: Nov. 11, 2021
(86) PCT No.: PCT/TR2021/051193

§ 371 Date: Jun. 30, 2023

(30) Foreign Application Priority Data
Dec. 31, 2020 (TR) 2020/22763

(51) Int. Cl. A01G 7/04; A01G 31/02

(52) U.S. Cl. CPC A01G 7/045; A01G 31/02

(57) ABSTRACT

An agricultural unit for providing breeding of plants that can detect the data related to the biological medium needed by the plant, having a chamber which can enable positioning and growing of the plant and an illumination element which can give light for growing of the plant on said chamber. The illumination element has a germination mode for providing optimum development of the plant in the germination period and configured to emit at least blue light, red light and far red light, a growing mode for providing optimum development of the plant in the duration between the germination and fruiting periods and configured to emit at least white light in addition to said germination mode, and a fruiting mode for providing optimum development of the plant in the fruiting period and configured to emit at least white light, red light and far red light.

### CROSS REFERENCE TO RELATED APPLICATIONS

This application is the national phase entry of International Application No. PCT/TR2021/051193, filed on Nov. 11, 2021, which is based upon and claims priority to Turkish Patent Application No. 2020/22763, filed on Dec. 31, 2020, the entire contents of which are incorporated herein by reference.

### TECHNICAL FIELD

The present invention relates to an agricultural unit for providing breeding of plants particularly in areas like houses, offices and configured to be able to detect the data related to the biological medium needed by the plant and comprising at least one chamber which can enable positioning and growing of the plant thereof and at least one illumination element which can give light for growing of the plant on said chamber.

### BACKGROUND

Damaging of nature more every passing day because of human activities creates a serious threaten for life of all living beings. Pollution of the environment leads to global warming by deteriorating the balance of eco-system. Since the density of greenhouse gases released to atmosphere increases depending on fossil fuel usage, the temperature of the planet further increases and global temperature increase leads to climate change which creates a big danger for the living being types. As processes like pandemic occur now, social interaction is tried to be reduced as much as possible. As a result of this, humans have tried to find alternative ways for becoming self-sufficient.

Humans now try to breed particularly the plants, which they will eat, in their houses. For this reason, people have begun to produce vegetables and fruits in their houses by using a specific amount of soil. Plants like tomato, pepper, lettuce, sweet basil, basil, mint, strawberry are begun to be grown in flowerpots.

When plant breeding is realized in flowerpot medium, problems like flyblowing, infestation occur which are based on soil usage. In this case, home comfort of people can be affected in an unfavorable manner. The biggest problems of flowerpot breeding in houses are the insufficiency of light taking duration of plants (insufficiency of photosynthesis duration) and since the watering process is manual, the breeder may forget watering, and since the care in breeding in soil is tiring, plant losses may take place. In a period where seasonality, unforeseen weather conditions and global warming make agriculture difficult every passing day, the plants which are bred in houses cannot grow sufficiently.

In flowerpot breeding, the pesticide (agricultural chemicals), used for preventing infestation in traditional agricultural applications and in greenhouses, gives serious damages to human health. Moreover, when this condition occurs in a house, the damage of the work exceeds the benefit of the work. LEDs, used in the present art against light insufficiency, become insufficient for optimum growth of plants by means of given light wavelengths. Moreover, leaving the watering of such plants to the initiative of the persons may lead to watering faults.

As a result, because of the abovementioned problems, an improvement is required in the related technical field.

### SUMMARY

The present invention relates to an agricultural unit, for eliminating the abovementioned disadvantages and for bringing new advantages to the related technical field.

An object of the present invention is to provide an agricultural unit particularly for use in mediums like houses, offices.

In order to realize the abovementioned objects and the objects which are to be deducted from the detailed description below, the present invention is an agricultural unit for providing breeding of plants particularly in areas like houses, offices and configured to be able to detect the data related to the biological medium needed by the plant and comprising at least one chamber which can enable positioning and growing of the plant thereof and at least one illumination element which can give light for growing of the plant on said chamber. Accordingly, the improvement is that said illumination element comprises at least one germination mode for providing optimum development of the plant in the germination period and configured to emit at least blue light, red light and far red light, at least one growing mode for providing optimum development of the plant in the duration between the germination and fruiting periods and configured to emit at least white light in addition to said germination mode, at least one fruiting mode for providing optimum development of the plant in the fruiting period and configured to emit at least white light, red light and far red light. Thus, plants can be grown in closed areas like houses and offices, and the medium needed by the plants while they are being grown is optimized.

In a possible embodiment of the present invention, Photosynthetic Photon Flux Density provided to the plant in said germination mode is between 50 and 150 μmol/(m²s). Thus, the illumination element is utilized in the best manner in the germination period of the plant, and the germination process can be completed in shorter duration.

In another possible embodiment of the present invention, Photosynthetic Photon Flux Density provided to the plant in said growing mode is between 100 and 500 μmol/(m²s). Thus, the plant utilizes the illumination element in the best manner during the growing period of the plant.

In another possible embodiment of the present invention, Photosynthetic Photon Flux Density provided to the plant in said fruiting mode is between 70 and 460 μmol/(m²s). Thus, the plant utilizes the illumination element in the best manner during the fruiting period of the plant.

In another possible embodiment of the present invention, the operation of the illumination element is controllable by means of at least one control unit. Thus, the operation duration of the illumination element, provided in the agricultural unit, is taken under control.

In another possible embodiment of the present invention, the operation of the illumination element is controllable by at least one control unit. Thus, the operation duration of the watering system, provided in the agricultural unit, is taken under control.

In another possible embodiment of the present invention, the passage of the illumination element between modes is controllable by at least one virtual memory unit. Thus, the passage of the illumination element between modes is taken under control.

In another possible embodiment of the present invention, the passage of the illumination element between modes is changeable manually by means of a mobile device by the user.

Thus, the passage of the illumination element between modes is controlled by the user.

In another possible embodiment of the present invention, the illumination element is essentially made in telescopic structure for providing approaching and diverging of the illumination element to/from the chamber. Thus, the illumination element can be positioned at different heights with respect to the chamber depending on the growth of the plant.

In another possible embodiment of the present invention, hydroponic growing method is applied in plant breeding. Thus, the agricultural unit provides contribution to the plant production without using soil and provides water saving.

### BRIEF DESCRIPTION OF THE FIGURES

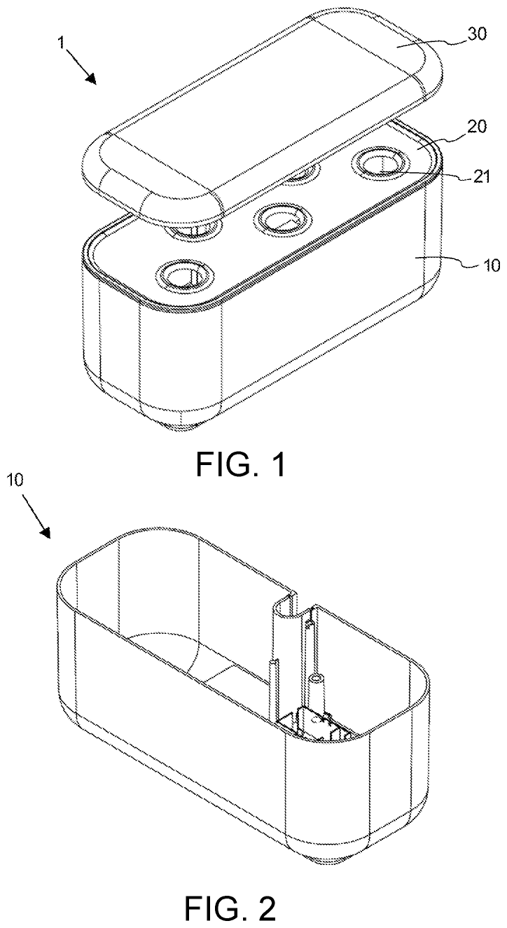

In FIG. 1, a representative perspective view of the subject matter agricultural unit is given.

In FIG. 2, a representative perspective view of the chamber provided in the subject matter agricultural unit is given.

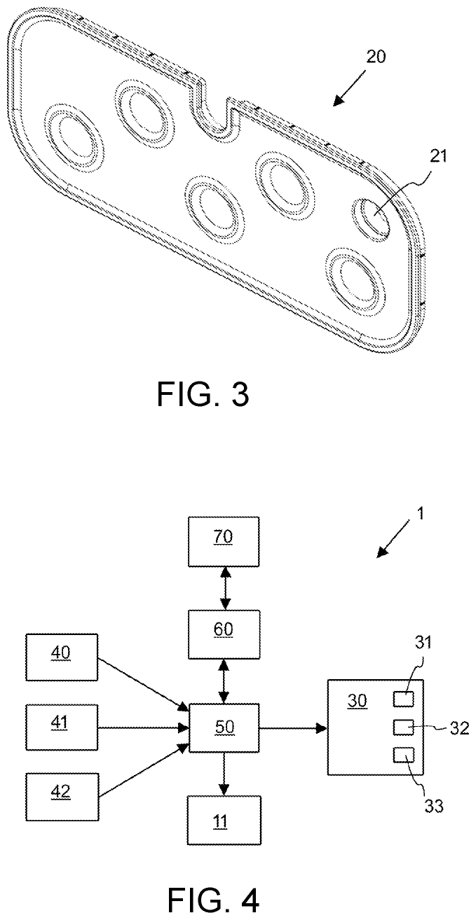

In FIG. 3, a representative perspective view of the cover of the subject matter agricultural unit is given.

In FIG. 4, a representative schematic view which shows the operation structure of the subject matter agricultural unit is given.

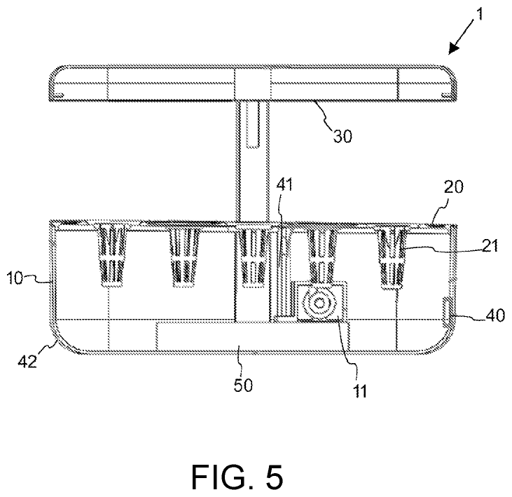

In FIG. 5, a representative cross-sectional view which shows the operation structure of the subject matter agricultural unit is given.

### DETAILED DESCRIPTION OF THE INVENTION

The components shown in the FIGS. are each given reference numbers as follows:
1 Agricultural unit,
10 Chamber,
11 Pump,
20 Cover,
21 Seeding capsule housing,
30 Illumination element,
31 Germination mode,
32 Growing mode,
33 Fruiting mode,
40 Heat/humidity sensor,
41 Liquid level sensor,
42 Air quality sensor,
50 Control unit,
60 Virtual memory unit,
70 Mobile device.

In this detailed description, the subject matter is explained with references to examples without forming any restrictive effect only in order to make the subject more understandable.

In FIG. 1, a representative perspective view of the subject matter agricultural unit (1) is given. Accordingly, said agricultural unit (1) is configured to enable plant growing in closed areas particularly like houses, offices. Thanks to the agricultural unit (1), persons can grow plants in houses in a professional manner. The agricultural unit (1) has a structure where IoT (internet of objects) technology and hydroponic growing method which shall be detailed hereunder are used together.

The agricultural unit (1), which joins hydroponic growing method and internet of objects (IoT) technology, enables breeding of vegetables (lettuce, rocket, spinach, etc.), aromatic plants (basil, sweet basil, mint, etc.), fruits (tomato, pepper, strawberry, etc.) and some flowers (nasturtium, electric flower, etc.) without using soil in closed medium.

In FIG. 2, a representative perspective view of a chamber (10) which is provided in the subject matter agricultural unit (1) is given. Accordingly, said chamber (10) is an element like a vessel wherein the elements needed by a plant root, positioned thereon, are positioned. The chamber (10) essentially provides plant growing by means of hydroponic growing method. Hydroponic breeding is an agriculture form applied in still water culture without soil. Plants utilize a food solution comprising minerals needed by the plant instead of the food which exist in the soil. Therefore, instead of searching minerals in the whole of the soil, plants can take food directly from food solution in an easy manner. Seeding viols like sand, peat, vermiculite, pearlite, coconut, rock wool or expanded clay aggregate are used for supporting the plants and the root systems of plants. The seeding viol can be defined as an element which has a porous structure which can hold the seed in a tight manner and which can feed roots by enclosing liquid in this porous structure. The liquid, which exists in the chamber (10), is essentially nutrient water. The water is circulated in the chamber (10) by means of at least one pump (11), and the subsiding of water and the reduction in oxygen level are prevented. Thanks to this, undesired putrefactions at the roots are prevented.

In FIG. 3, a representative perspective view of the cover (20) of the subject matter agricultural unit (1) is given. Accordingly, at least one cover (20) can be positioned at the upper vicinity of the chamber (10). There is at least one seeding capsule housing (21) on said cover (20). Said seeding capsule housing (21) essentially has a recess form of the cover (20) opened towards the chamber (10) and the plant can be grown therein. In a possible embodiment of the present invention, the number of seeding capsule housings (21) can be changed depending on the chamber (10) size and the element to be grown, and the size of the seeding capsule housing (21) can be formed in a predetermined manner. In a possible embodiment of the present invention, the upper part of the seeding capsule housings (21) can be closed by an opaque cover as needed. By means of this, the undesired algae growth can be prevented and germination can be reinforced.

There is at least one illumination element (30) on the agricultural unit (1). Said illumination element (30) is essentially a light source. In a possible embodiment of the present invention, the illumination element (30) can be fixed on the chamber (10) and is positioned in a manner giving light from the upper part of the plant towards the chamber (10). The illumination element (30) can be produced in telescopic structure such that the height thereof can be changed with respect to the chamber (10) depending on plant growth. The illumination element (30) provides obtaining of the light needed by the plant for photosynthesis. In the illumination element (30),

LED chip numbers, colors thereof and the placements thereof are provided at a specific arrangement for providing growing together of plants which need different wavelengths and frequencies at the same time. The hours, where the illumination element (30) shall give light for the plant, can be adjusted in predetermined manner by means of a control unit (50) and can be controlled by the mobile application which communicates with this control unit (50).

Said mobile application can be loaded onto a mobile device (70), and by means of this, control facility by the user is also provided.

By means of the mobile application, the users can track their productions in the process as from seeding to the harvest. When the seeding date and the product type are entered, the users can reach medium temperature and humidity information at the same time by means of mobile application, where approximately expected harvest date can be seen, and humidity information and medium CO 2 concentration information. At the same time, when these values and liquid level exceed the critical range, the users shall be informed by means of instantaneous notifications. In the agricultural unit (1), the mobile application, where the growing hints related to vegetable, fruit and plants which have flowers to be grown are provided, takes the function of virtual assistant for the user.

In the illumination element (30), there are three separate illumination modes/LED chip sets. Each of these has been configured in a manner emitting light at different wavelengths and is used in an efficient manner at different periods of plant growth. In the agricultural unit (1), the illumination element (30) has been configured to operate in three different modes. The lights which are turned on in different modes of the illumination element (30) are provided in a manner meeting the needs of the plant in the period of the plant. LED technology, provided at the illumination element (30), functions through PPFD (Photo-synthetic Photon Flux Density) values. These PPFD values give the photon requirement needed for the plant growth. Since this value shall change in accordance with the distance of the light with respect to the plant, the PPDF ranges used on the system are as given hereunder.

The photons which are needed for the first development of the plant are provided by means of a germination mode (31). In this mode, blue, red and far red lights, which are provided on the illumination element (30), are turned on and begin to germinate the plant. The far red light used here triggers the growing hormones of the plant and germination the plant in a very rapid manner. By means of blue, red and far red lights used in the germination mode (31), 50-150 μmol/(m²s) PPFD values are provided to the plant and optimum development of the plant in the germination period is provided.

After the germination step, a growing mode (32) is activated. In the growing mode (32), the PAR (photosynthetic active radiation) value which must be taken by the plants is kept at the maximum level and the growing process is realized in the most efficient manner. Here, white light is also activated in a different manner from the germination mode (31). Yellow and green spectrums are activated together with white light, beta carotene, chlorophyll A, phytochrome Pr ve phytochrome Pfr are affected in a favorable manner. All light used in the growing mode (32) gives us a PPFD value between 100 and 500 μmol/(m²s). Greeneries with foliages need a value between 100 and 400 μmol/(m²s). Thus, the illumination element (30) provides light such that the plant shall be developed in the optimum manner in the growing period. Until the plants with green foliages and without fruit are harvested, the developments are completed when light with above mentioned values is provided.

The plants with fruit enter into fruiting period after the growing period. In this period, the illumination element (30) passes to the fruiting mode (33). In this mode, the phytochrome Pfr photo-receptor, needed by the plant, is given in the most correct manner. In this period, the plants search an activator for fruiting. In the fruiting mode (33), the blue light in the illumination element (30) is turned off, and the red and far red lights are used. In this mode, the white lights support red and far red light and design is made such that the duration which passes during fruiting period is minimized. The white, red and far red lights used in the fruiting mode (33) provide a light value to the plant between 70 and 460 μmol/(m²s).

In FIG. 4, a representative schematic view which shows the operation structure of the subject matter agricultural unit (1) is given. Accordingly, in the agricultural unit (1), plant growth can be tracked by means of IoT technology as described. IoT technology comprises communicating of objects with humans and provides informing of humans about any condition. In the step of applying this technology in the agricultural unit (1), the biological need of the plant on the agricultural unit (1) is detected and the user is warned. The persons are warned by means of a mobile application which operates in a mobile device (70) which is suitable for personal use. There is wireless connection between the mobile device (70) and the virtual memory unit (60) and communication is provided by means of internet. The virtual memory unit (60) provides loading of biological critical values needed by the plant and transferring of warning to the mobile application in the mobile device (70) depending on these values.

In the agricultural unit (1), in order to be able to detect the biological condition of the plant and the medium, there are various sensors and a control unit (50) connected to these sensors. Said control unit (50) collects the data, received from these sensors, under a single roof and is used in function of transferring to the virtual memory unit (60). The sensors and the functions thereof used in the virtual memory unit (60) shall be hereunder described.

In the agricultural unit (1), there is at least one heat/humidity sensor (40). Said heat/humidity sensor (40) is configured to detect the temperature and humidity amount in the medium where the agriculture unit (1) exists. It can send the result of the made determination to the control unit (50).

There is at least one level sensor (41) at the agricultural unit (1). Said liquid level sensor (41) is configured to detect the sufficiency for the plant and the height of the liquid inside the chamber (10). Information is given to the control unit (50) depending on the made liquid level detection.

There is at least one air quality sensor (42) in the agricultural unit (1). Said air quality sensor (42) is essentially configured to detect CO₂ level of air. The studies made put forward that while the plants realize photosynthesis, they substantially decrease CO₂ proportion in the medium. Under normal conditions, the CO₂ density in closed mediums is between 350 ppm and 1000 ppm. There is no problem for the humans and plants living in the room within this range, but when this range is exceeded, unfavorable results can occur both for humans and plants.

In a possible embodiment of the invention, in the agricultural unit (1), sufficient amount of water is added into the chamber (10) and mineral and vitamin can be added as needed. Afterwards, seeding viols are added to the seeding capsule housings (21) and the seed is left therein or seeding viols, wherein the seed is ready, are directly placed to seeding capsule housings. And the system is energized. In this case, in the agricultural unit (1), the pump (11) circulates the liquid in the chamber (10) with periodic intervals. For germination of the plant, the illumination element (30) is passed to the germination mode (31). After the completion of the germination of the plant, the illumination element (30) is passed to the growing mode (32). If the plant, which has grown by time, is a plant with fruits (tomato, pepper, strawberry, etc.), the illumination element (30) is passed to the fruiting mode (33) while the plant enters the fruiting period. Thanks to this, high-quality fruits are obtained in optimum duration in plant growth. In a possible embodiment, the passage between the modes can also be changed by the user by means of a mobile device (70) which has mobile application. Moreover, during the growth of the plant, in case the standard is exceeded in phenomena like liquid level, air quality inside the chamber (10), humidity, temperature needed by the medium, the user can be warned by the mobile application.

In alternative embodiments of the invention, in the agricultural unit (1), aquaponic breeding or aeroponic breeding methods can also be applied instead of the hydroponic breeding method. Aquaponic breeding is basically the ability of breeding of consumable plant and water products. In other words, here, the plants and fishes can be grown together in agricultural unit (1). This may be defined as a kind of poly-culture. Thanks to this, besides plant breeding in the agricultural kit, also fish can be bred. Said aeroponic breeding is a method applied in the form of spraying food melts to the roots of plants continuously or intermittently in the form of fog or vapor. In this system, there are headings which provide applying of the food solution and there is the motor mechanism which operates the system in a pressurized manner.

Together with all these embodiments, the illumination element (30) used in agriculture unit (30) enables development of the plant in the best manner. Besides, since there shall be no infestation, bad smell, etc. thanks to application of hydroponic breeding, products which do not include pesticide (agricultural chemical) can be grown. By means of usage of low voltage pump (11), the problems of high level of noise and insufficiency of oxygen which goes to roots are eliminated. By means of the sensors used, optimum medium is formed for the plant. The agricultural unit (1) enables production of food, needed by persons, in an independent manner from external conditions and in a fresh manner without chemicals.

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

What is claimed is:

1. An agricultural unit for providing breeding of a plant, configured to detect the data related to a biological medium needed by the plant and comprising:
at least one chamber which can enable positioning and growing of the plant, and
at least one illumination element which can give light for growing of the plant, on said chamber,
wherein said illumination element comprises:
at least one germination mode for providing optimum development of the plant in the germination period and configured to emit at least blue light, red light and far red light,
at least one growing mode for providing optimum development of the plant in the duration between the germination and fruiting periods and configured to emit at least white light in addition to said germination mode, and
at least one fruiting mode (33) for providing optimum development of the plant in the fruiting period and configured to emit at least white light, red light and far red light.

2. The agricultural unit according to claim 1, wherein, when the illumination element is in the germination mode, Photosynthetic Photon Flux Density provided to the plant is between 50 and 150 μmol/(m²s).

3. The agricultural unit according to claim 1, wherein, when the illumination element is in the growing mode, Photosynthetic Photon Flux Density provided to the plant is between 100 and 500 μmol/(m²s).

4. The agricultural unit according to claim 1, wherein, when the illumination element is in the fruiting mode, Photosynthetic Photon Flux Density provided to the plant is between 70 and 460 μmol/(m²s).

5. The agricultural unit according to claim 1, further comprising at least one control unit, wherein the operation of the illumination element is controllable by the at least one control unit.

6. The agricultural unit according to claim 1, further comprising at least one virtual memory unit, wherein the passage of the illumination element between modes is controllable by the at least one virtual memory unit.

7. The agricultural unit according to claim 1, wherein the passage of the illumination element between modes is configured to be changeable manually by means of a mobile device operated by a user.

8. The agricultural unit according to claim 1, wherein the illumination element comprises a telescopic structure for providing approaching and diverging of the illumination element to/from the chamber.

9. A method of using the agricultural unit according to claim 1, comprising the step of: hydroponically breeding a plant in the agricultural unit.
